(19) United States
(12) Patent Application Publication
(10) Pub. No.: US 2015/0081852 A1
(43) Pub. Date: Mar. 19, 2015

(54) PROXY RELATIONSHIP PROCESSING METHOD AND SYSTEM, PROXY SERVER, AND TERMINAL

(71) Applicant: Huawei Technologies Co., Ltd., Shenzhen (CN)

(72) Inventors: Shuangxi Liu, Shenzhen (CN); Dongxue Shi, Shenzhen (CN); Mengjun Fan, Hongzhou (CN)

(21) Appl. No.: 14/548,085

(22) Filed: Nov. 19, 2014

Related U.S. Application Data
(63) Continuation of application No. PCT/CN2013/074413, filed on Apr. 19, 2013.

(30) Foreign Application Priority Data
Sep. 29, 2012 (CN) 201210374767.1

(51) Int. Cl. H04L 29/08

(52) U.S. Cl. CPC H04L 67/16; H04L 67/28; H04L 67/32
USPC 709/219

(57) ABSTRACT

This disclosure provides a proxy relationship processing method and system, a proxy server, and a terminal, where the method includes: the proxy server receiving a service content request sent including an account of a first terminal and a service item by another terminal; searching, according to the account of the first terminal, a preset proxy relationship table corresponding to the account of the first terminal to obtain a proxy-enabled service item from the proxy relationship table; and if it is learned, according to the proxy relationship table, that the service item is the proxy-enabled service item, sending the service content request to a second terminal corresponding to the proxy-enabled service item, so that the second terminal sends a service content request response to the other terminal according to the service content request. This resolves problems of limited application and low proxy efficiency of an existing proxy relationship processing method.

### CROSS-REFERENCE TO RELATED APPLICATIONS

This application is a continuation of International Application No. PCT/CN2013/074413, filed on Apr. 19, 2013, which claims priority to Chinese Patent Application No. 201210374767.1, filed on Sep. 29, 2012, both of which are hereby incorporated by reference in their entireties.

### TECHNICAL FIELD

Embodiments of the present invention relate to the field of communications technologies, and in particular, to a proxy relationship processing method and system, a proxy server, and a terminal.

### BACKGROUND

During work, an enterprise member does not work at a work station due to frequent business trips or meetings, and therefore the enterprise member needs to quickly delegate the work.

An existing proxy relationship processing method is email proxy. That is, an authorizer needs to make an application first, and, after the application is completed, needs to set menus one by one and notify a related person by email; the related person can learn a proxy relationship only by email, and knows nothing about the proxy relationship, a proxied item, the authorizer, and a proxy if the related person misses the email. Knowing nothing about the proxy relationship, another contact cannot obtain a timely reply when initiating a call or text chatting to the authorizer. Therefore, proxy efficiency is low.

Another proxy relationship processing method is a proxy manner of using a proxy robot. However, content proxied by the proxy robot is limited, and a question beyond a proxy scope cannot be answered; moreover, work content, a voice conference, and the like, of a member cannot be proxied. Therefore, application is limited.

In conclusion, the existing proxy relationship processing methods based on email delegation and a proxy robot have problems of limited application and low proxy efficiency.

### SUMMARY

The present invention provides a proxy relationship processing method and system, a proxy server, and a terminal, so as to resolve problems of limited application and low proxy efficiency of an existing proxy relationship processing method.

According to a first aspect, the present invention provides a proxy relationship processing method, including:

receiving, by a proxy server, a service content request sent by another terminal, where the service content request includes an account of a first terminal and a service item;

searching, according to the account of the first terminal, a preset proxy relationship table corresponding to the account of the first terminal; and

if it is learned, according to the proxy relationship table, that the service item is a proxy-enabled service item, sending the service content request to a second terminal corresponding to the proxy-enabled service item, so that the second terminal sends a service content request response to the other terminal according to the service content request.

In a first possible implementation manner, before the receiving, by a proxy server, a service content request sent by another terminal, the method includes:

receiving, by the proxy server, a proxy setting request sent by the first terminal, where the proxy setting request includes at least one to-be-proxied service item and an account of the second terminal corresponding to the service item;

sending the proxy setting request to the second terminal corresponding to the account of the second terminal, so that the second terminal returns a proxy setting response;

receiving the proxy setting response and creating the proxy relationship table corresponding to the account of the first terminal, where the proxy relationship table includes a correspondence between the to-be-proxied service item and the account of the second terminal; and

sending, to the first terminal, the proxy setting response sent by the second terminal, so that the first terminal establishes the correspondence between the to-be-proxied service item and the account of the second terminal.

Based on the first possible implementation manner, in a second possible implementation manner, after the receiving the proxy setting response and creating the proxy relationship table corresponding to the account of the first terminal, the method includes:

receiving, by the proxy server, a proxy enabling request sent by the first terminal, where the proxy enabling request includes at least one to-be-proxy-enabled service item;

searching the proxy relationship table corresponding to the account of the first terminal, activating the to-be-proxy-enabled service item to make it a proxy-enabled service item, and obtaining the account of the second terminal corresponding to the proxy-enabled service item; and

sending proxy enabling notifications of the service item respectively to the first terminal and the second terminal, where the proxy enabling notifications of the service item each include corresponding proxy prompt content, so that the first terminal and the second terminal perform displaying respectively according to their respective proxy prompt content.

Based on the first aspect, the first or second possible implementation manner, in a third possible implementation manner, the method further includes:

obtaining, by the proxy server, a friend list corresponding to the account of the first terminal; and

sending a proxy relationship notification of the proxy-enabled service item to any terminal corresponding to the friend list, where the proxy relationship notification includes the proxy-enabled service item, the account of the second terminal, and the account of the first terminal.

Based on the first aspect, the first, second or the third possible implementation manner, in a fourth possible implementation manner, the service item includes at least one of text chatting, an incoming call, an email, a conference, and conference schedule management.

According to a second aspect, the present invention provides a proxy relationship processing method, including:

receiving, by a first terminal, a service content request and a service content request response sent by a proxy server, where the service content request is a service content request sent by another terminal to the proxy server, and the service content request response is sent by a second terminal to the other terminal according to the service content request, where the proxy server searches, according to an account of the first terminal included in the service content request, a preset proxy relationship table corresponding to the account of the first terminal, and if it is learned, according to the proxy relationship table, that a service item included in the service content request is a proxy-enabled service item, sends the service content request to the second terminal corresponding to the proxy-enabled service item, so that the second terminal sends the service content request response to the other terminal according to the service content request; and

displaying the service content request and the service content request response.

In a first possible implementation manner, before the receiving, by a first terminal, a service content request and a service content request response sent by a proxy server, the method includes:

sending, by the first terminal, a proxy setting request to the proxy server, where the proxy setting request includes at least one to-be-proxied service item and an account of the second terminal corresponding to the service item, so that the proxy server sends the proxy setting request to the second terminal; and

receiving a proxy setting response sent by the proxy server and establishing a correspondence between the to-be-proxied service item and the account of the second terminal, where

the proxy setting response is a proxy setting response returned by the second terminal to the proxy server according to the proxy setting request.

Based on the first possible implementation manner, in a second possible implementation manner, after the receiving a proxy setting response sent by the proxy server and establishing a correspondence between the to-be-proxied service item and the account of the second terminal, the method includes:

sending, by the first terminal, a proxy enabling request to the proxy server, where the proxy enabling request includes at least one to-be-proxy-enabled service item, so that the proxy server searches the proxy relationship table corresponding to the account of the first terminal, activates the to-be-proxy-enabled service item to make it a proxy-enabled service item, obtains the account of the second terminal corresponding to the proxy-enabled service item, and sends a proxy enabling notification of the service item to the second terminal;

receiving a proxy enabling notification that is of the service item and sent by the proxy server, where the proxy enabling notification of the service item includes proxy prompt content corresponding to the first terminal; and

displaying the proxy prompt content corresponding to the first terminal.

Based on the second possible implementation manner, in a third possible implementation manner, the proxy prompt content corresponding to the first terminal includes text prompt content and personal avatar prompt content that are corresponding to the first terminal, where the text prompt content corresponding to the first terminal includes prompt content indicating that the first terminal is being proxied by the second terminal; and

the displaying the proxy prompt content corresponding to the first terminal specifically includes:

displaying the prompt content indicating that the first terminal is being proxied by the second terminal; and

displaying both a personal avatar of the first terminal and a personal avatar of the second terminal

According to a third aspect, the present invention provides a proxy relationship processing method, including:

receiving, by a second terminal, a service content request sent by a proxy server, where the service content request is a service content request sent by another terminal to the proxy server, so that the proxy server searches, according to an account of a first terminal included in the service content request, a preset proxy relationship table corresponding to the account of the first terminal, and if it is learned, according to the proxy relationship table, that a service item included in the service content request is a proxy-enabled service item, sends the service content request to a second terminal corresponding to the proxy-enabled service item; and

returning a service content request response to the proxy server according to the service content request, so that the proxy server sends the service content request response to the other terminal and the first terminal.

In a first possible implementation manner, before the receiving, by a second terminal, a service content request sent by a proxy server, the method includes:

receiving, by the second terminal, a proxy setting request sent by the proxy server, where the proxy setting request includes at least one to-be-proxied service item and an account of the second terminal corresponding to the service item, and the proxy setting request is a proxy setting request sent by the first terminal to the proxy server; and

sending a proxy setting response to the proxy server according to the proxy setting request, so that the proxy server creates, according to the proxy setting response, the proxy relationship table corresponding to the account of the first terminal, and sends the proxy setting response to the first terminal, where the proxy relationship table includes a correspondence between the to-be-proxied service item and the account of the second terminal.

Based on the first possible implementation manner, in a second possible implementation manner, after the sending a proxy setting response to the proxy server according to the proxy setting request, the method includes:

receiving, by the second terminal, a proxy enabling notification that is of the service item corresponding to the second terminal and sent by the proxy server, where the proxy enabling notification of the service item corresponding to the second terminal includes proxy prompt content corresponding to the second terminal; and

displaying the proxy prompt content corresponding to the second terminal.

Based on the second possible implementation manner, in a third possible implementation manner, the proxy prompt content corresponding to the second terminal includes text prompt content and personal avatar prompt content that are corresponding to the second terminal, where the text prompt content corresponding to the second terminal includes prompt content indicating that the second terminal is serving as a proxy for the first terminal; and

the displaying the proxy prompt content corresponding to the second terminal specifically includes:

displaying the prompt content indicating that the second terminal is serving as a proxy for the first terminal; and

displaying both a personal avatar of the second terminal and a personal avatar of the first terminal.

According to a fourth aspect, the present invention provides a proxy server, including:

a first receiving module, configured to receive a service content request sent by another terminal, where the service content request includes an account of a first terminal and a service item;

a querying module, configured to search, on the basis of the account of the first terminal received by the first receiving module and according to the account of the first terminal, a preset proxy relationship table corresponding to the account of the first terminal; and

a determining module, configured to send, on the basis that the querying module learns, by querying the proxy relationship table, that the service item is a proxy-enabled service item, the service content request to a second terminal corresponding to the proxy-enabled service item, so that the second terminal sends a service content request response to the other terminal according to the service content request.

Based on the fourth aspect, in a first possible implementation manner, the first receiving module is further configured to receive a proxy setting request sent by the first terminal, where the proxy setting request includes at least one to-be-proxied service item and an account of the second terminal corresponding to the service item; and

the proxy server further includes:

a first sending module, configured to send the proxy setting request received by the first receiving module to the second terminal corresponding to the account of the second terminal, so that the second terminal returns a proxy setting response; where

the first receiving module is further configured to receive the proxy setting response and create the proxy relationship table corresponding to the account of the first terminal, where the proxy relationship table includes a correspondence between the to-be-proxied service item and the account of the second terminal; and

the first sending module is further configured to send, to the first terminal, the proxy setting response sent by the second terminal, so that the first terminal establishes the correspondence between the to-be-proxied service item and the account of the second terminal.

Based on the first possible implementation manner of the fourth aspect, in a second possible implementation manner, the first receiving module is further configured to receive a proxy enabling request sent by the first terminal, where the proxy enabling request includes at least one to-be-proxy-enabled service item; and

the proxy server further includes:

a setting module, configured to search, on the basis of the proxy enabling request received by the first receiving module, the proxy relationship table corresponding to the account of the first terminal, activate the to-be-proxy-enabled service item to make it a proxy-enabled service item, and obtain the account of the second terminal corresponding to the proxy-enabled service item; where

the first sending module is further configured to send, on the basis that the setting module activates the to-be-proxy-enabled service item to make it a proxy-enabled service item, proxy enabling notifications of the service item respectively to the first terminal and the second terminal, where the proxy enabling notifications of the service item each include corresponding proxy prompt content, so that the first terminal and the second terminal perform displaying respectively according to their respective proxy prompt content.

Based on the fourth aspect or the first or second possible implementation manner of the fourth aspect, in a third possible implementation manner, the querying module is further configured to query a friend list corresponding to the account of the first terminal; and

the first sending module is further configured to send a proxy relationship notification of the proxy-enabled service item to any terminal corresponding to the friend list, where the proxy relationship notification includes the proxy-enabled service item, the account of the second terminal, and the account of the first terminal.

Based on the fourth aspect or any one of the first to third possible implementation manners of the fourth aspect, in a fourth possible implementation manner, the service item includes at least one of text chatting, an incoming call, an email, a conference, and conference schedule management.

According to a fifth aspect, the present invention provides a terminal, including:

a second receiving module, configured to receive a service content request and a service content request response sent by a proxy server, where the service content request is a service content request sent by another terminal to the proxy server, and the service content request response is sent by a second terminal to the other terminal according to the service content request, where the proxy server searches, according to an account of the terminal included in the service content request, a preset proxy relationship table corresponding to the account of the terminal, and if it is learned, according to the proxy relationship table, that a service item included in the service content request is a proxy-enabled service item, sends the service content request to the second terminal corresponding to the proxy-enabled service item, so that the second terminal sends the service content request response to the other terminal according to the service content request; and

a first displaying module, configured to display the service content request and the service content request response.

Based on the fifth aspect, in a first possible implementation manner, the terminal further includes:

a second sending module, configured to send a proxy setting request to the proxy server, where the proxy setting request includes at least one to-be-proxied service item and an account of a further terminal corresponding to the service item, so that the proxy server sends the proxy setting request to the further terminal; where

the second receiving module is further configured to receive a proxy setting response sent by the proxy server and establish a correspondence between the to-be-proxied service item and the account of the further terminal, where the proxy setting response is a proxy setting response returned by the further terminal to the proxy server according to the proxy setting request.

Based on the first possible implementation manner of the fifth aspect, in a second possible implementation manner, the second sending module is further configured to send a proxy enabling request to the proxy server, where the proxy enabling request includes at least one to-be-proxy-enabled service item, so that the proxy server searches the proxy relationship table corresponding to the account of the terminal, activates the to-be-proxy-enabled service item to make it a proxy-enabled service item, obtains the account of the further terminal corresponding to the proxy-enabled service item, and sends a proxy enabling notification of the service item to the further terminal;

the second receiving module is further configured to receive the proxy enabling notification that is of the service item and sent by the proxy server, where the proxy enabling notification of the service item includes proxy prompt content corresponding to the terminal; and

the first displaying module is further configured to display the proxy prompt content corresponding to the terminal.

Based on the second possible implementation manner of the fifth aspect, in a third possible implementation manner, the proxy prompt content corresponding to the terminal includes text prompt content and personal avatar prompt content that are corresponding to the terminal, where the text prompt content corresponding to the terminal includes prompt content indicating that the terminal is being proxied by the further terminal; and

the first displaying module is specifically configured to:

display the prompt content indicating that the terminal is being proxied by the further terminal; and

display both a personal avatar of the terminal and a personal avatar of the further terminal.

Based on the fifth aspect or any one of the first to third possible implementation manners of the fifth aspect, in a fourth possible implementation manner, the service item includes at least one of text chatting, an incoming call, an email, a conference, and conference schedule management.

According to a sixth aspect, the present invention provides a terminal, including:

a third receiving module, configured to receive a service content request sent by a proxy server, where the service content request is a service content request sent by another terminal to the proxy server, so that the proxy server searches, according to an account of a further terminal included in the service content request, a preset proxy relationship table corresponding to the account of the further terminal, and if it is learned, according to the proxy relationship table, that a service item included in the service content request is a proxy-enabled service item, sends the service content request to a terminal corresponding to the proxy-enabled service item; and

a third sending module, configured to return a service content request response to the proxy server according to the service content request, so that the proxy server sends the service content request response to the other terminal and the further terminal.

Based on the sixth aspect, in a first possible implementation manner, the third receiving module is further configured to receive a proxy setting request sent by the proxy server, where the proxy setting request includes at least one to-be-proxied service item and an account of the terminal corresponding to the service item, and the proxy setting request is a proxy setting request sent by the further terminal to the proxy server; and

the third sending module is further configured to send a proxy setting response to the proxy server according to the proxy setting request, so that the proxy server creates, according to the proxy setting response, the proxy relationship table corresponding to the account of the further terminal, and sends the proxy setting response to the further terminal, where the proxy relationship table includes a correspondence between the to-be-proxied service item and the account of the terminal.

Based on the first possible implementation manner of the sixth aspect, in a second possible implementation manner, the third receiving module is further configured to receive a proxy enabling notification that is of the service item corresponding to the terminal and sent by the proxy server, where the proxy enabling notification of the service item corresponding to the terminal includes proxy prompt content corresponding to the terminal; and

the terminal further includes:

a second displaying module, configured to display the proxy prompt content corresponding to the terminal.

Based on the second possible implementation manner of the sixth aspect, in a third possible implementation manner, the proxy prompt content corresponding to the terminal includes text prompt content and personal avatar prompt content that are corresponding to the terminal, where the text prompt content corresponding to the terminal includes prompt content indicating that the terminal is serving as a proxy for the further terminal; and

the second displaying module is specifically configured to:

display the prompt content indicating that the terminal is serving as a proxy for the further terminal; and

display both a personal avatar of the terminal and a personal avatar of the further terminal.

Based on the sixth aspect or any one of the first to third possible implementation manners of the sixth aspect, in a fourth possible implementation manner, the service item includes at least one of text chatting, an incoming call, an email, a conference, and conference schedule management.

According to a seventh aspect, the present invention provides a proxy relationship processing system, including a proxy server, a first terminal, and a second terminal, where the proxy server is the foregoing proxy server; the first terminal is the terminal according to the fifth aspect; and the second terminal is the terminal according to the sixth aspect.

According to an eighth aspect, the present invention provides a proxy server, including a processor, a memory, and a communications bus, where the processor and the memory are connected by using the communications bus, and the memory stores an instruction for implementing a proxy relationship processing method. When the processor invokes the instruction in the memory, the following steps may be executed:

receiving a service content request sent by another terminal, where the service content request includes an account of a first terminal and a service item;

searching, according to the account of the first terminal, a preset proxy relationship table corresponding to the account of the first terminal; and

if it is learned, according to the proxy relationship table, that the service item is a proxy-enabled service item, sending the service content request to a second terminal corresponding to the proxy-enabled service item, so that the second terminal sends a service content request response to the other terminal according to the service content request.

Based on the eighth aspect, in a first possible implementation manner, before the receiving a service content request sent by another terminal, the steps include:

receiving a proxy setting request sent by the first terminal, where the proxy setting request includes at least one to-be-proxied service item and an account of the second terminal corresponding to the service item;

sending the proxy setting request to the second terminal corresponding to the account of the second terminal, so that the second terminal returns a proxy setting response;

receiving the proxy setting response and creating the proxy relationship table corresponding to the account of the first terminal, where the proxy relationship table includes a correspondence between the to-be-proxied service item and the account of the second terminal; and

sending, to the first terminal, the proxy setting response sent by the second terminal, so that the first terminal establishes the correspondence between the to-be-proxied service item and the account of the second terminal.

Based on the first possible implementation manner of the eighth aspect, in a second possible implementation manner, after the receiving the proxy setting response and creating the proxy relationship table corresponding to the account of the first terminal, the steps include:

receiving a proxy enabling request sent by the first terminal, where the proxy enabling request includes at least one to-be-proxy-enabled service item;

searching the proxy relationship table corresponding to the account of the first terminal, activating the to-be-proxy-enabled service item to make it a proxy-enabled service item, and obtaining the account of the second terminal corresponding to the proxy-enabled service item; and

sending proxy enabling notifications of the service item respectively to the first terminal and the second terminal, where the proxy enabling notifications of the service item each include corresponding proxy prompt content, so that the first terminal and the second terminal perform displaying respectively according to their respective proxy prompt content.

Based on the eighth aspect or the first or second possible implementation manner of the eighth aspect, in a third possible implementation manner, the processor may further execute the following steps:

obtaining a friend list corresponding to the account of the first terminal; and

sending a proxy relationship notification of the proxy-enabled service item to any terminal corresponding to the friend list, where the proxy relationship notification includes the proxy-enabled service item, the account of the second terminal, and the account of the first terminal.

Based on the eighth aspect or any one of the first to third possible implementation manners of the eighth aspect, in a fourth possible implementation manner, the service item includes at least one of text chatting, an incoming call, an email, a conference, and conference schedule management.

According to a ninth aspect, the present invention provides a terminal, including: a processor, a memory, and a communications bus, where the processor and the memory are connected by using the communications bus, and the memory stores an instruction for implementing a proxy relationship processing method. When the processor invokes the instruction in the memory, the following steps may be executed:

receiving a service content request and a service content request response sent by a proxy server, where the service content request is a service content request sent by another terminal to the proxy server, and the service content request response is sent by a further terminal to the other terminal according to the service content request, where the proxy server searches, according to an account of the terminal included in the service content request, a preset proxy relationship table corresponding to the account of the terminal, and if it is learned, according to the proxy relationship table, that a service item included in the service content request is a proxy-enabled service item, sends the service content request to the further terminal corresponding to the proxy-enabled service item, so that the further terminal sends the service content request response to the another terminal according to the service content request; and

displaying the service content request and the service content request response.

Based on the ninth aspect, in a first possible implementation manner, before the receiving a service content request and a service content request response sent by a proxy server, the steps include:

sending a proxy setting request to the proxy server, where the proxy setting request includes at least one to-be-proxied service item and an account of the further terminal corresponding to the service item, so that the proxy server sends the proxy setting request to the further terminal; and

receiving a proxy setting response sent by the proxy server and establishing a correspondence between the to-be-proxied service item and the account of the further terminal, where

the proxy setting response is a proxy setting response returned by the further terminal to the proxy server according to the proxy setting request.

Based on the first possible implementation manner of the ninth aspect, in a second possible implementation manner, after the receiving a proxy setting response sent by the proxy server and establishing a correspondence between the to-be-proxied service item and the account of the further terminal, the steps include:

sending a proxy enabling request to the proxy server, where the proxy enabling request includes at least one to-be-proxy-enabled service item, so that the proxy server searches the proxy relationship table corresponding to the account of the terminal, activates the to-be-proxy-enabled service item to make it a proxy-enabled service item, obtains the account of the further terminal corresponding to the proxy-enabled service item, and sends a proxy enabling notification of the service item to the further terminal;

receiving the proxy enabling notification that is of the service item and sent by the proxy server, where the proxy enabling notification of the service item includes proxy prompt content corresponding to the terminal; and

displaying the proxy prompt content corresponding to the terminal.

Based on the second possible implementation manner of the ninth aspect, in a third possible implementation manner, the proxy prompt content corresponding to the terminal includes text prompt content and personal avatar prompt content that are corresponding to the terminal, where the text prompt content corresponding to the terminal includes prompt content indicating that the terminal is being proxied by the further terminal; and

the displaying the proxy prompt content corresponding to the terminal specifically includes:

displaying the prompt content indicating that the terminal is being proxied by the further terminal; and

displaying both a personal avatar of the terminal and a personal avatar of the further terminal.

Based on the ninth aspect or any one of the first to third possible implementation manners of the ninth aspect, in a fourth possible implementation manner, the service item includes at least one of text chatting, an incoming call, an email, a conference, and conference schedule management.

According to a tenth aspect, the present invention provides a terminal, including: a processor, a memory, and a communications bus, where the processor and the memory are connected by using the communications bus, and the memory stores an instruction for implementing a proxy relationship processing method. When the processor invokes the instruction in the memory, the following steps may be executed:

receiving a service content request sent by a proxy server, where the service content request is a service content request sent by another terminal to the proxy server, so that the proxy server searches, according to an account of a further terminal included in the service content request, a preset proxy relationship table corresponding to the account of the further terminal, and if it is learned, according to the proxy relationship table, that a service item included in the service content request is a proxy-enabled service item, sends the service content request to a terminal corresponding to the proxy-enabled service item; and

returning a service content request response to the proxy server according to the service content request, so that the proxy server sends the service content request response to the other terminal and the further terminal.

Based on the tenth aspect, in a first possible implementation manner, before the receiving a service content request sent by a proxy server, the steps include:

receiving a proxy setting request sent by the proxy server, where the proxy setting request includes at least one to-be-proxied service item and an account of the terminal corresponding to the service item, and the proxy setting request is a proxy setting request sent by the further terminal to the proxy server; and

sending a proxy setting response to the proxy server according to the proxy setting request, so that the proxy server creates, according to the proxy setting response, the proxy relationship table corresponding to the account of the further terminal, and sends the proxy setting response to the further terminal, where the proxy relationship table includes a correspondence between the to-be-proxied service item and the account of the terminal.

Based on the first possible implementation manner of the tenth aspect, in a second possible implementation manner, after the sending a proxy setting response to the proxy server according to the proxy setting request, the steps include:

receiving a proxy enabling notification that is of the service item corresponding to the terminal and sent by the proxy server, where the proxy enabling notification of the service item corresponding to the terminal includes proxy prompt content corresponding to the terminal; and

displaying the proxy prompt content corresponding to the terminal.

Based on the second possible implementation manner of the tenth aspect, in a third possible implementation manner, the proxy prompt content corresponding to the terminal includes text prompt content and personal avatar prompt content that are corresponding to the terminal, where the text prompt content corresponding to the terminal includes prompt content indicating that the terminal is serving as a proxy for the further terminal; and

the displaying the proxy prompt content corresponding to the terminal specifically includes:

displaying the prompt content indicating that the terminal is serving as a proxy for the further terminal; and

displaying both a personal avatar of the terminal and a personal avatar of the further terminal.

Based on the tenth aspect or any one of the first to third possible implementation manners of the tenth aspect, in a fourth possible implementation manner, the service item includes at least one of text chatting, an incoming call, an email, a conference, and conference schedule management.

In embodiments of the present invention, a proxy server may, when receiving a service content request sent by another terminal to a first terminal, determine whether a service item included in the service content request is a proxy-enabled service item; and if yes, directly send the service content request to a second terminal corresponding to the proxy-enabled service item, so that the second terminal makes a service content request response in a timely manner, which may implement that when the other terminal sends the service content request to the first terminal (a proxied terminal) even without learning a proxy relationship, the proxy server may send the service content request to the second terminal (a proxy terminal) in a timely manner, so that the second terminal replies to the other terminal in a timely manner, which improves proxy efficiency, and may resolve a problem of low proxy efficiency of a method based on email proxy.

A proxied item or the service item in the embodiments of the present invention includes but is not limited to at least one of text chatting, an incoming call, an email, a conference, and conference schedule management. The proxied items are abundant and expandable. Moreover, the second terminal, as a proxy terminal, may, according to an instruction of a proxy, make a flexible response to the service content request sent by the other terminal, which may resolve a problem of limited application of a method based on proxy by using a proxy robot.

Moreover, in the embodiments of the present invention, the first terminal and the second terminal separately perform visual displaying according to corresponding proxy prompt content sent by the proxy server. For example, after proxy is enabled, personal avatars displayed by the first terminal include a personal avatar of the first terminal and a personal avatar of the second terminal. For another example, a text prompt displayed by the first terminal is “You are being proxied by the second terminal”, or a text prompt displayed by the second terminal is “You are acting as a proxy for the first terminal”, which can improve user experience.

### BRIEF DESCRIPTION OF THE DRAWINGS

To describe the technical solutions in the embodiments of the present invention more clearly, the following briefly introduces the accompanying drawings required for describing the embodiments. Apparently, the accompanying drawings in the following description show some embodiments of the present invention, and persons of ordinary skill in the art may still derive other drawings from these accompanying drawings without creative efforts.

FIG. 1 is a schematic flowchart of a proxy relationship processing method according to an embodiment of the present invention;

FIG. 2 is a schematic diagram of a menu for switching to a proxy party mode used in an embodiment of the present invention;

FIG. 3 is a schematic diagram of a menu of proxy prompt content used in an embodiment of the present invention;

FIG. 4 is a schematic diagram of another menu of proxy prompt content used in an embodiment of the present invention;

FIG. 5 is a schematic diagram of a text chatting window used in an embodiment of the present invention;

FIG. 6 is a schematic flowchart of a proxy relationship processing method according to another embodiment of the present invention;

FIG. 7 is a schematic flowchart of a proxy relationship processing method according to another embodiment of the present invention;

FIG. 8 is a schematic structural diagram of a proxy server according to another embodiment of the present invention;

FIG. 9 is a schematic structural diagram of a terminal according to another embodiment of the present invention;

FIG. 10 is a schematic structural diagram of a terminal according to another embodiment of the present invention;

FIG. 11 is a schematic structural diagram of a proxy relationship processing system according to another embodiment of the present invention;

FIG. 12 is a schematic structural diagram of a proxy server according to another embodiment of the present invention;

FIG. 13 is a schematic structural diagram of a terminal according to another embodiment of the present invention; and

FIG. 14 is a schematic structural diagram of a terminal according to another embodiment of the present invention.

### DETAILED DESCRIPTION

To make the objectives, technical solutions, and advantages of the embodiments of the present invention clearer, the following clearly describes the technical solutions in the embodiments of the present invention with reference to the accompanying drawings in the embodiments of the present invention. Apparently, the described embodiments are a part rather than all of the embodiments of the present invention. All other embodiments obtained by persons of ordinary skill in the art based on the embodiments of the present invention without creative efforts shall fall within the protection scope of the present invention.

Existing proxy relationship processing methods based on email delegation and proxy by using a proxy robot have problems of limited application and low proxy efficiency. The embodiments of the present invention provide a proxy relationship processing method, which can resolve the problems of limited application and low proxy efficiency of the existing proxy relationship processing methods, thereby improving proxy efficiency.

It should be noted that in the following, a first terminal is a proxied terminal, a second terminal is a proxy terminal, another terminal is any terminal other than the first terminal and the second terminal, an account of the first terminal includes a user name of the first terminal, and an account of the second terminal includes a user name of the second terminal.

The embodiments of the present invention may be applied to an application scenario in which a same communications software terminal is installed on a proxy server, the first terminal, the second terminal, and the other terminal.

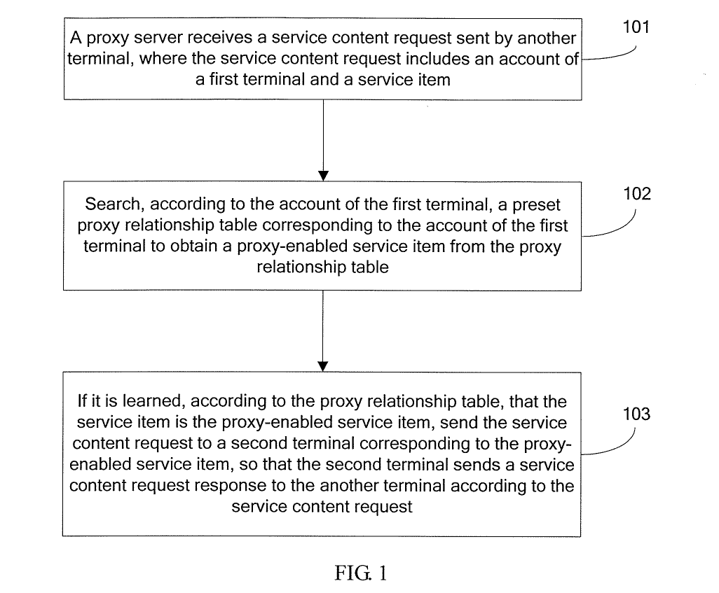

FIG. 1 is a schematic flowchart of a proxy relationship processing method according to an embodiment of the present invention. As shown in FIG. 1, the method specifically includes the following:

101. A proxy server receives a service content request sent by another terminal, where the service content request includes an account of a first terminal and a service item.

It should be noted that the service item includes but is not limited to at least one of text chatting, an incoming call, an email, a conference, and conference schedule management. The other terminal may be any terminal corresponding to a friend list of the first terminal, or a terminal of another contact, where the terminal of the other contact may be another terminal other than the first terminal, a second terminal, and the any terminal corresponding to the friend list of the first terminal.

102. Search, according to the account of the first terminal, a preset proxy relationship table corresponding to the account of the first terminal.

In an optional embodiment of the present invention, before step 101, the proxy server receives a proxy setting request sent by the first terminal, where the proxy setting request includes at least one to-be-proxied service item and an account of a second terminal serving as a proxy for the service item, which may be as follows during specific implementation:

The first terminal, that is, a proxied terminal, may locally set, according to an instruction of an authorizer, the to-be-proxied service item, which may specifically include but is not limited to at least one of text chatting, an incoming call, an email, a conference, and conference schedule management. The first terminal may further select a proxy from contacts of the first terminal or an enterprise address book according to the instruction of the authorizer. During specific selection of the proxy, one proxy may be selected to act as a proxy for a plurality of service items to be proxied, or one proxy may be selected to act as a proxy for one to-be-proxied service item, which is not limited in the present invention. The first terminal may send the proxy setting request to the proxy server according to the instruction of the authorizer, where the proxy setting request includes at least one to-be-proxied service item and the account of the second terminal serving as a proxy for the service item. It should be noted that the account of the second terminal refers to an account of a proxy terminal corresponding to the to-be-proxied service item that is set by the first terminal.

The proxy server sends the proxy setting request to the second terminal (the terminal corresponding to the account of the second terminal), so that the second terminal makes a proxy setting response according to the proxy setting request, which may be as follows during specific implementation: the second terminal receives the proxy setting request forwarded by the proxy server and displays, in a pop-up manner, a prompt box asking, for example, agree to act as a proxy for A or not; and the second terminal returns, after agree is tapped according to an instruction of the proxy, the proxy setting response to the proxy server; or the second terminal may return, after disagree is tapped according to the instruction of the proxy, no proxy setting response to the proxy server.

The proxy server receives the proxy setting response, and may create the proxy relationship table corresponding to the account of the first terminal, where the proxy relationship table includes a correspondence between the to-be-proxied service item and the account of the second terminal. Table 1 is a proxy relationship table that is corresponding to the account of the first terminal and is created by the proxy server, as shown in Table 1.

| | Service | | Activated |
|---|---|---|---|
| Authorizer | item | Proxy | or not |
| An account of a | Text | An account of a second | Not enabled |
| first terminal | chatting | terminal is set | |
| An account of a | Incoming | An account of a second | Not enabled |
| first terminal | call | terminal is set | |
| An account of a | Conference | Not set | Not set and |
| first terminal | schedule | | cannot be |
| | | | activated |
| An account of a | Contact | Not set | Not set and |
| first terminal | | | cannot be |
| | | | activated |

The proxy server sends, to the first terminal, the proxy setting response sent by the second terminal, so that the first terminal establishes the correspondence between the to-be-proxied service item and the account of the second terminal.

In an optional embodiment of the present invention, the proxy server may receive a proxy enabling request sent by the first terminal, where the proxy enabling request includes at least one to-be-proxy-enabled service item, and the to-be-proxy-enabled service item specifically refers to a to-be-proxied service item that is set by the first terminal, which may be as follows during specific implementation:

FIG. 2 is a schematic diagram of a menu for switching to a proxy party mode used in an embodiment of the present invention. As shown in FIG. 2, the first terminal sends, according to the instruction of the authorizer, the proxy enabling request to the proxy server by tapping Switch to a proxy party mode in a drop-down menu box, which may implement a function of enabling a proxy service by tapping one key.

The proxy server searches, according to the proxy enabling request, the proxy relationship table corresponding to the account of the first terminal, activates the to-be-proxy-enabled service item to make it a proxy-enabled service item, and obtains the account of the second terminal corresponding to the proxy-enabled service item, which may be as follows during specific implementation:

The proxy server refreshes, according to the received proxy enabling request, the proxy relationship table corresponding to the account of the first terminal. Table 2 is a refreshed proxy relationship table corresponding to the account of the first terminal, as shown in Table 2.

| | Service | | Activated |
|---|---|---|---|
| Authorizer | item | Proxy | or not |
| An account of a first | Text | An account of a second | Enabled |
| terminal | chatting | terminal is set | |
| An account of a first | Incoming | An account of a second | Enabled |
| terminal | call | terminal is set | |

The proxy server sends proxy enabling notifications of the service item respectively to the first terminal and the second terminal, where the proxy enabling notifications of the service item each include corresponding proxy prompt content, so that the first terminal and the second terminal perform displaying respectively according to their respective proxy prompt content, which may be as follows during specific implementation:

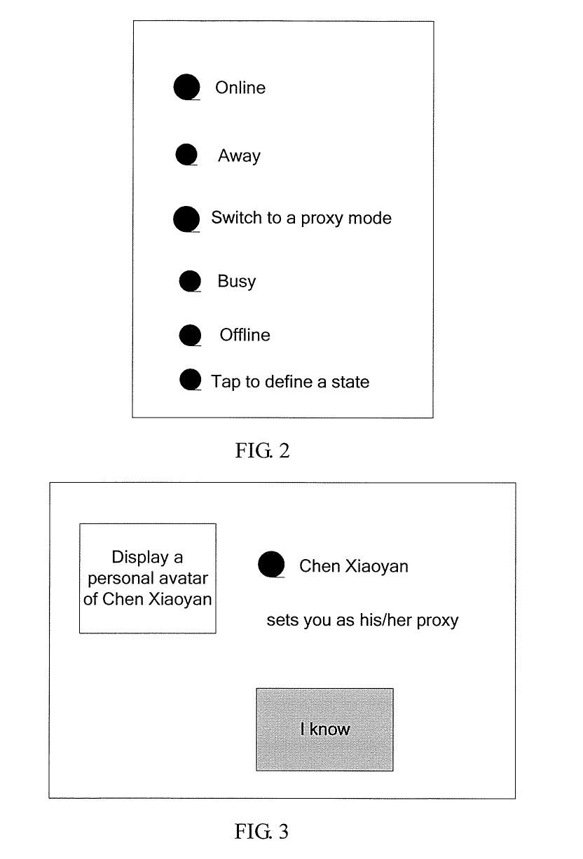

The proxy prompt content included in the proxy enabling notification that is of the service item and sent by the proxy server to the second terminal may be “The first terminal sets the second terminal as a proxy of the first terminal”. FIG. 3 is a schematic diagram of a menu of proxy prompt content used in an embodiment of the present invention. As shown in FIG. 3, it is assumed that the account of the first terminal is Chen Xiaoyan and the account of the second terminal is Xu Dong; when receiving the proxy enabling notification that is of the service item and sent by the proxy server, the second terminal may display the proxy prompt content included in the proxy enabling notification of the service item. As shown in FIG. 3, the second terminal displays, in a pop-up manner, a prompt box indicating “Chen Xiaoyan sets you as his/her proxy”. Further, the proxy prompt content received by the second terminal may further include that a personal avatar of the second terminal changes. Before receiving the proxy enabling notification of the service item, the second terminal displays only the personal avatar of the second terminal; after receiving the proxy enabling notification of the service item, the second terminal displays the personal avatar of the second terminal and a personal avatar of the first terminal.

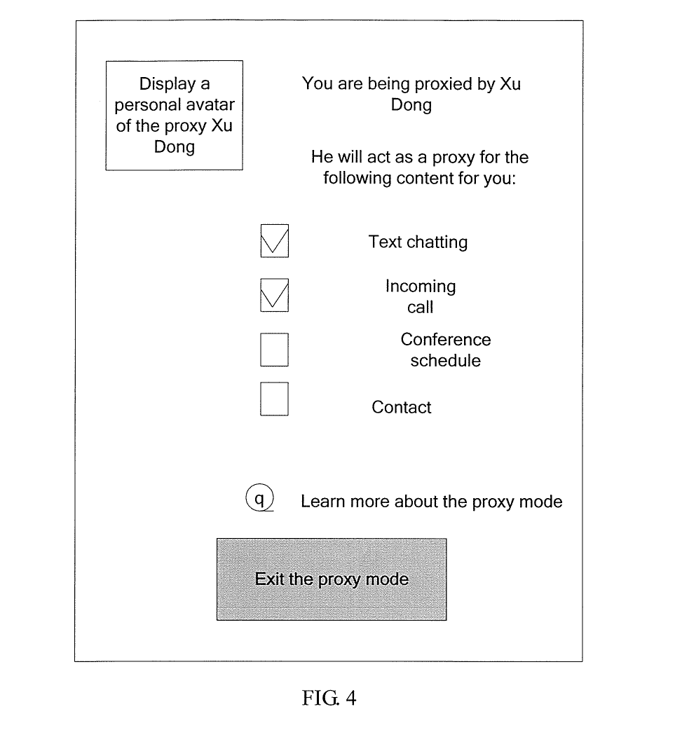

The proxy prompt content included in the proxy enabling notification that is of the service item and sent by the proxy server to the first terminal may be “The first terminal is being proxied by the second terminal”. FIG. 4 is a schematic diagram of another menu of proxy prompt content used in an embodiment of the present invention. As shown in FIG. 4, it is assumed that the account of the first terminal is Chen Xiaoyan and the account of the second terminal is Xu Dong; when receiving the proxy enabling notification that is of the service item and sent by the proxy server, the first terminal may display the proxy prompt content included in the proxy enabling notification of the service item. For example, the first terminal displays, in a pop-up manner, a prompt box indicating “You are being proxied by Xu Dong”. Further, the prompt box may further include a proxied service item. It should be noted that the first terminal may change the proxied service item according to an instruction of the authorizer. The foregoing prompt box may further include a menu of “Exit the proxy mode”, and the first terminal may tap, according to an instruction of the authorizer, “Exit the proxy mode” to exit the proxy mode. Further, the proxy prompt content received by the first terminal may further include that a personal avatar of the first terminal changes. Before receiving the proxy enabling notification of the service item, the first terminal displays only the personal avatar of the first terminal; after receiving the proxy enabling notification of the service item, the first terminal displays the personal avatar of the first terminal and the personal avatar of the second terminal.

In an optional embodiment of the present invention, the proxy server may obtain a friend list corresponding to the account of the first terminal, and send a proxy relationship notification of the proxy-enabled service item to a terminal corresponding to each friend in the friend list, where the proxy relationship notification includes the proxy-enabled service item, the account of the second terminal, and the account of the first terminal. Further, after receiving the proxy relationship notification, the terminal corresponding to the friend list, for example, displays, in a pop-up manner, a prompt box, where prompt content in the prompt box includes that “The first terminal is being proxied by the second terminal”; the prompt content further includes a proxy item (a proxied service item); and the prompt content further includes the personal avatar of the first terminal and the personal avatar of the second terminal that are displayed on a terminal of a friend.

103. If it is learned, according to the proxy relationship table, that the service item is a proxy-enabled service item, send the service content request to a second terminal corresponding to the proxy-enabled service item, so that the second terminal sends a service content request response to the other terminal according to the service content request.

In an optional embodiment of the present invention, the proxy server may record the service content request sent to the second terminal, and send the recorded service content request to the first terminal, so that the first terminal learns service content that is proxied by the second terminal, which may be as follows during specific implementation:

For example, when a friend or another contact of the first terminal initiates a call to the first terminal, the proxy server determines that calls of the first terminal are proxied by the second terminal; and the proxy server plays a ring back tone to a terminal corresponding to the friend or another contact who initiates the call, so as to prompt through audio that the first terminal is being proxied by the second terminal, and then connects the second terminal and directly routes the call to the second terminal. The first terminal obtains only one call record notification, which records that a call made by a friend at a moment is taken over by the second terminal. When the second terminal answers the call, the proxy server plays a prompt tone, so as to prompt that the current call is made by the friend looking for the first terminal and is proxied by the second terminal.

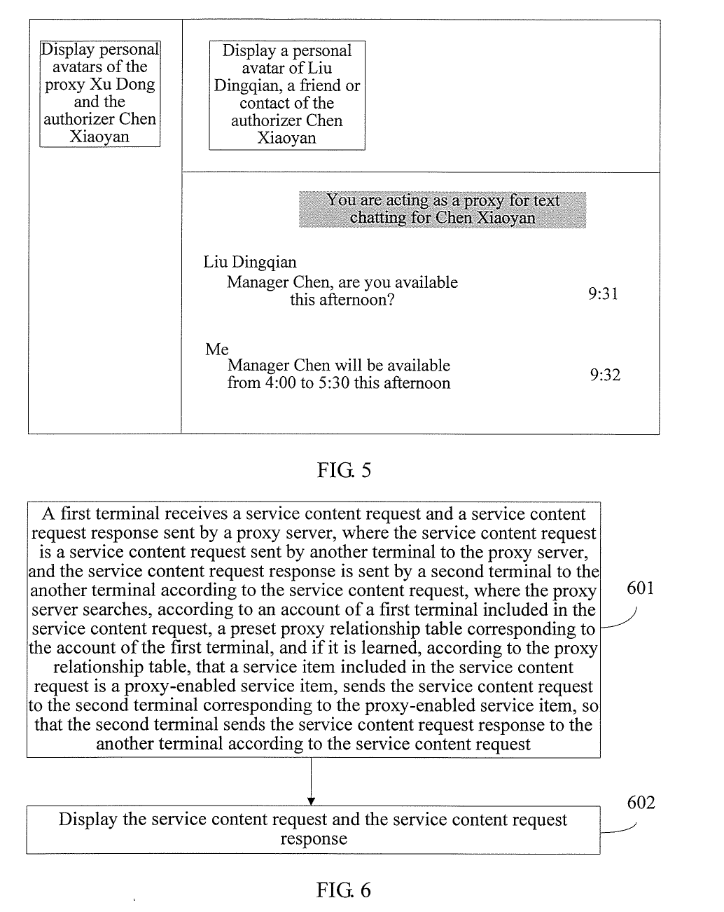

For another example, FIG. 5 is a schematic diagram of a text chatting window used in an embodiment of the present invention. As show in FIG. 5, when a friend or another contact of the first terminal sends text chatting information to the first terminal, the proxy server determines that text chatting of the first terminal is proxied by the second terminal; and the proxy server returns prompt information “The first terminal is being proxied by the second terminal” to a terminal corresponding to the friend or another contact who initiates the text chatting, and then sends text chatting content to the second terminal at the same time; when a text chatting window of the second terminal receives the text chatting content sent by the friend or another contact of the first terminal, the text chatting window of the second terminal displays a conspicuous prompt message “You are acting as a proxy for text chatting for the first terminal”, for example, “You are acting as a proxy for text chatting for Chen Xiaoyan”. Further, the text chatting window of the second terminal may further display a conspicuous prompt message “Another terminal is looking for the first terminal”, for example, “Liu Dingqian is looking for Chen Xiaoyan”. As shown in FIG. 5, text chatting content sent by Liu Dingqian is “Manager Chen, are you available this afternoon?” Because the text chatting of Chen Xiaoyan is being proxied by Xu Dong, Xu Dong may reply, as a proxy for Chen Xiaoyan, that “Manager Chen will be available from 4:00 to 5:30 this afternoon”.

It should be noted that, to help the first terminal learn the service content proxied by the second terminal, the proxy server may send, to the first terminal, the service content request sent by the other terminal and the service content request response returned by the second terminal. For example, the proxy server may send, to the first terminal, the text chatting content “Manager Chen, are you available this afternoon?” sent by Liu Dingqian and “Manager Chen will be available from 4:30 to 5:00 this afternoon” replied by Xu Dong as a proxy for Chen Xiaoyan, so that Chen Xiaoyan reads, when becoming available, the text chatting content of Xu Dong as a proxy for Chen Xiaoyan.

In an optional embodiment of the present invention, the proxy server may receive a proxy cancelling request or a proxy changing request sent by the first terminal, where the proxy cancelling request includes at least one proxied item to be cancelled, and the proxy changing request includes a request for changing a proxy or a request for changing a proxied service item; the proxy server performs, according to the received proxy cancelling request or proxy changing request, a corresponding operation of cancelling the proxy or operation of changing the proxy, which may be as follows during specific implementation:

For example, the proxy server searches, according to the proxy cancelling request, the proxy relationship table corresponding to the account of the first terminal, and changes the proxy-enabled service item to a service item for which proxy is not enabled or a service item for which proxy is not activated.

For another example, the proxy server searches, according to the proxy changing request, the proxy relationship table corresponding to the account of the first terminal, and changes a corresponding service item or changes a corresponding proxy terminal (for example, changes the account of the second terminal to an account of another terminal).

In this embodiment of the present invention, a proxy server may, when receiving a service content request sent by another terminal to a first terminal, determine whether a service item included in the service content request is a proxy-enabled service item; and if yes, directly send the service content request to a second terminal corresponding to the proxy-enabled service item, so that the second terminal makes a service content request response in a timely manner, which may implement that when the other terminal sends the service content request to the first terminal (a proxied terminal) even without learning a proxy relationship, the proxy server may send the service content request to the second terminal (a proxy terminal) in a timely manner, so that the second terminal replies to the other terminal in a timely manner, which improves proxy efficiency, and may resolve a problem of low proxy efficiency of a method based on email proxy.

A proxied item or the service item in this embodiment of the present invention includes but is not limited to at least one of text chatting, an incoming call, an email, a conference, and conference schedule management. The proxied items are abundant and expandable. Moreover, the second terminal, as a proxy terminal, may, according to an instruction of a proxy, make a flexible response to the service content request sent by the other terminal, which may resolve a problem of limited application of a method based on proxy by using a proxy robot.

Moreover, in this embodiment of the present invention, the first terminal and the second terminal separately perform visual displaying according to corresponding proxy prompt content sent by the proxy server. For example, after proxy is enabled, personal avatars displayed by the first terminal include a personal avatar of the first terminal and a personal avatar of the second terminal. For another example, a text prompt displayed by the first terminal is “You are being proxied by the second terminal”, or a text prompt displayed by the second terminal is “You are acting as a proxy for the first terminal”, which may improve user experience.

FIG. 6 is a schematic flowchart of a proxy relationship processing method according to another embodiment of the present invention. As shown in FIG. 6, the method specifically includes the following:

601. A first terminal receives a service content request and a service content request response sent by a proxy server, where the service content request is a service content request sent by another terminal to the proxy server, and the service content request response is sent by a second terminal to the other terminal according to the service content request, where the proxy server searches, according to an account of the first terminal included in the service content request, a preset proxy relationship table corresponding to the account of the first terminal, and if it is learned, according to the proxy relationship table, that a service item included in the service content request is a proxy-enabled service item, sends the service content request to the second terminal corresponding to the proxy-enabled service item, so that the second terminal sends the service content request response to the other terminal according to the service content request.

In an optional embodiment of the present invention, before step 601, the first terminal sends a proxy setting request to the proxy server, where the proxy setting request includes at least one to-be-proxied service item and an account of the second terminal corresponding to the service item, so that the proxy server sends the proxy setting request to the second terminal; and receives a proxy setting response sent by the proxy server and establishes a correspondence between the to-be-proxied service item and the account of the second terminal, where the proxy setting response is a proxy setting response returned by the second terminal to the proxy server according to the proxy setting request. Reference may be made to description of related content in the embodiment shown in FIG. 1 for specific implementation, which is not described repeatedly.

In an optional embodiment of the present invention, the first terminal may send a proxy enabling request to the proxy server, where the proxy enabling request includes at least one to-be-proxy-enabled service item, so that the proxy server searches the proxy relationship table corresponding to the account of the first terminal, activates the to-be-proxy-enabled service item to make it a proxy-enabled service item, obtains the account of the second terminal corresponding to the proxy-enabled service item, sends a proxy enabling notification of the service item to the second terminal; receive a proxy enabling notification that is of the service item and sent by the proxy server, where the proxy enabling notification of the service item includes proxy prompt content corresponding to the first terminal; and display the proxy prompt content corresponding to the first terminal.

The proxy prompt content corresponding to the first terminal includes text prompt content and personal avatar prompt content that are corresponding to the first terminal; and the text prompt content corresponding to the first terminal includes prompt content indicating that the first terminal is being proxied by the second terminal.

The displaying the proxy prompt content corresponding to the first terminal may be as follows during specific implementation: displaying the prompt content indicating that the first terminal is being proxied by the second terminal; and displaying both a personal avatar of the first terminal and a personal avatar of the second terminal. Reference may be made to related content in the embodiment shown in FIG. 1 for related description, which is not described repeatedly.

It should be noted that the foregoing service item includes at least one of text chatting, an incoming call, an email, a conference, and conference schedule management.

In an optional embodiment of the present invention, the first terminal may send a proxy cancelling request or a proxy changing request to the proxy server, where the proxy cancelling request includes at least one proxied item to be cancelled, and the proxy changing request includes a request for changing a proxy or a request for changing a proxied service item, so that the proxy server performs, according to the received proxy cancelling request or proxy changing request, a corresponding operation of cancelling the proxy and operation of changing the proxy.

602. Display the service content request and the service content request response.

In this embodiment of the present invention, a first terminal displays a service content request that is forwarded by a proxy server and from another terminal, and a service content request response from a second terminal, so as to implement that when the first terminal is proxied by the second terminal, the first terminal can also obtain service content proxied by the second terminal. Moreover, a service item in this embodiment of the present invention includes but is not limited to at least one of text chatting, an incoming call, an email, a conference, and conference schedule management. Proxied service items are abundant and expandable. Moreover, in this embodiment of the present invention, the first terminal performs visual displaying according to corresponding proxy prompt content sent by the proxy server. For example, after proxy is enabled, personal avatars displayed by the first terminal include a personal avatar of the first terminal and a personal avatar of the second terminal. For another example, a text prompt displayed by the first terminal is “You are being proxied by the second terminal”, which may improve user experience.

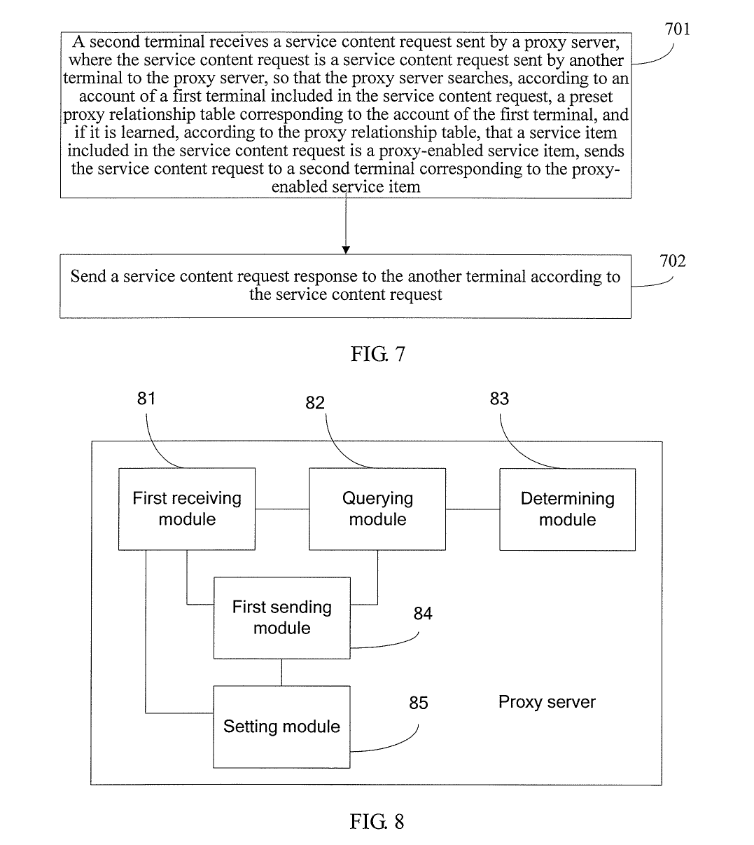

FIG. 7 is a schematic flowchart of a proxy relationship processing method according to another embodiment of the present invention. As shown in FIG. 7, the method specifically includes the following:

701. A second terminal receives a service content request sent by a proxy server, where the service content request is a service content request sent by another terminal to the proxy server, so that the proxy server searches, according to an account of a first terminal included in the service content request, a preset proxy relationship table corresponding to the account of the first terminal, and if it is learned, according to the proxy relationship table, that a service item included in the service content request is a proxy-enabled service item, sends the service content request to the second terminal corresponding to the proxy-enabled service item.

In an optional embodiment of the present invention, the second terminal receives a proxy setting request sent by the proxy server, where the proxy setting request includes at least one to-be-proxied service item and an account of the second terminal corresponding to the service item, and the proxy setting request is a proxy setting request sent by the first terminal to the proxy server; and sends a proxy setting response to the proxy server according to the proxy setting request, so that the proxy server creates, according to the proxy setting response, the proxy relationship table corresponding to the account of the first terminal, and sends the proxy setting response to the first terminal, where the proxy relationship table includes a correspondence between the to-be-proxied service item and the account of the second terminal. Reference may be made to related description in the embodiment shown in FIG. 1 for specific implementation, which is not described repeatedly.

In an optional embodiment of the present invention, the second terminal receives a proxy enabling notification that is of the service item corresponding to the second terminal and sent by the proxy server, where the proxy enabling notification of the service item corresponding to the second terminal includes proxy prompt content corresponding to the second terminal; and displays the proxy prompt content corresponding to the second terminal. The proxy prompt content corresponding to the second terminal includes text prompt content and personal avatar prompt content that are corresponding to the second terminal; and the text prompt content corresponding to the second terminal includes prompt content indicating that the second terminal is serving as a proxy for the first terminal. The displaying the proxy prompt content corresponding to the second terminal may be as follows during specific implementation: displaying the prompt content indicating that the second terminal is serving as a proxy for the first terminal; and displaying both a personal avatar of the second terminal and a personal avatar of the first terminal. Reference may be made to related description in the embodiment shown in FIG. 1 for details, which are not described repeatedly.

It should be noted that the service item includes at least one of text chatting, an incoming call, an email, a conference, and conference schedule management.

702. Send a service content request response to the other terminal according to the service content request.

In an optional embodiment of the present invention, the second terminal may send the service content request response to the proxy server, so that the proxy server sends the service content request response to the first terminal.

In this embodiment of the present invention, when a second terminal receives a service content request that is forwarded by a proxy server and from another terminal, the second terminal sends a service content request response to the other terminal in a timely manner according to the service content request, which may implement that when the other terminal sends the service content request to a first terminal (a proxied terminal) even without learning a proxy relationship, the proxy server may send the service content request to the second terminal (a proxy terminal) in a timely manner, so that the second terminal replies to the other terminal in a timely manner, which improves proxy efficiency, and may resolve a problem of low proxy efficiency of a method based on email proxy.

A service item in this embodiment of the present invention includes but is not limited to at least one of text chatting, an incoming call, an email, a conference, and conference schedule management. The service items are abundant and expandable. Moreover, the second terminal, as a proxy terminal, may, according to an instruction of a proxy, make a flexible response to the service content request sent by the other terminal, which may resolve a problem of limited application of a method based on proxy by using a proxy robot.

Moreover, in this embodiment of the present invention, the second terminal performs visual displaying according to corresponding proxy prompt content sent by the proxy server. For example, after proxy is enabled, personal avatars displayed by the second terminal include a personal avatar of the first terminal and a personal avatar of the second terminal. For another example, a text prompt displayed by the second terminal is “You are acting as a proxy for the first terminal”, which may improve user experience.

FIG. 8 is a schematic structural diagram of a proxy server according to another embodiment of the present invention. As shown in FIG. 8, the proxy server specifically includes:

a first receiving module 81, configured to receive a service content request sent by another terminal, where the service content request includes an account of a first terminal and a service item;

a querying module 82, configured to search, on the basis of the account of the first terminal received by the first receiving module and according to the account of the first terminal, a preset proxy relationship table corresponding to the account of the first terminal; and

a determining module 83, configured to send, on the basis that the querying module learns, by querying the proxy relationship table, that the service item is a proxy-enabled service item, the service content request to a second terminal corresponding to the proxy-enabled service item, so that the second terminal sends a service content request response to the other terminal according to the service content request.

In an optional embodiment of the present invention, the first receiving module 81 is further configured to receive a proxy setting request sent by the first terminal, where the proxy setting request includes at least one to-be-proxied service item and an account of the second terminal corresponding to the service item.

In an optional embodiment of the present invention, the proxy server further includes:

a first sending module 84, configured to send the proxy setting request received by the first receiving module to the second terminal corresponding to the account of the second terminal, so that the second terminal returns a proxy setting response; where

the first receiving module 81 is further configured to receive the proxy setting response and create the proxy relationship table corresponding to the account of the first terminal, where the proxy relationship table includes a correspondence between the to-be-proxied service item and the account of the second terminal; and

the first sending module 84 is further configured to send, to the first terminal, the proxy setting response sent by the second terminal, so that the first terminal establishes the correspondence between the to-be-proxied service item and the account of the second terminal.

In an optional embodiment of the present invention, the first receiving module 81 is further configured to receive a proxy enabling request sent by the first terminal, where the proxy enabling request includes at least one to-be-proxy-enabled service item.

In an optional embodiment of the present invention, the proxy server further includes:

a setting module 85, configured to search, on the basis of the proxy enabling request received by the first receiving module, the proxy relationship table corresponding to the account of the first terminal, activate the to-be-proxy-enabled service item to make it a proxy-enabled service item, and obtain the account of the second terminal corresponding to the proxy-enabled service item; where

the first sending module 84 is further configured to send, on the basis that the setting module activates the to-be-proxy-enabled service item to make it a proxy-enabled service item, proxy enabling notifications of the service item respectively to the first terminal and the second terminal, where the proxy enabling notifications of the service item each include corresponding proxy prompt content, so that the first terminal and the second terminal perform displaying respectively according to their respective proxy prompt content.

In an optional embodiment of the present invention, the querying module 82 is further configured to query a friend list corresponding to the account of the first terminal; where

the first sending module 83 is further configured to send, on the basis of the friend list that is obtained by the querying module and corresponds to the account of the first terminal, a proxy relationship notification of the proxy-enabled service item to any terminal corresponding to the friend list, where the proxy relationship notification includes the proxy-enabled service item, the account of the second terminal, and the account of the first terminal.

It should be noted that the foregoing service item includes at least one of text chatting, an incoming call, an email, a conference, and conference schedule management.

In this embodiment of the present invention, a proxy server may, when receiving a service content request sent by another terminal to a first terminal, determine whether a service item included in the service content request is a proxy-enabled service item; and if yes, directly send the service content request to a second terminal corresponding to the proxy-enabled service item, so that the second terminal makes a service content request response in a timely manner, which may implement that when the other terminal sends the service content request to the first terminal (a proxied terminal) even without learning a proxy relationship, the proxy server may send the service content request to the second terminal (a proxy terminal) in a timely manner, so that the second terminal replies to the other terminal in a timely manner, which improves proxy efficiency, and may resolve a problem of low proxy efficiency of a method based on email proxy.

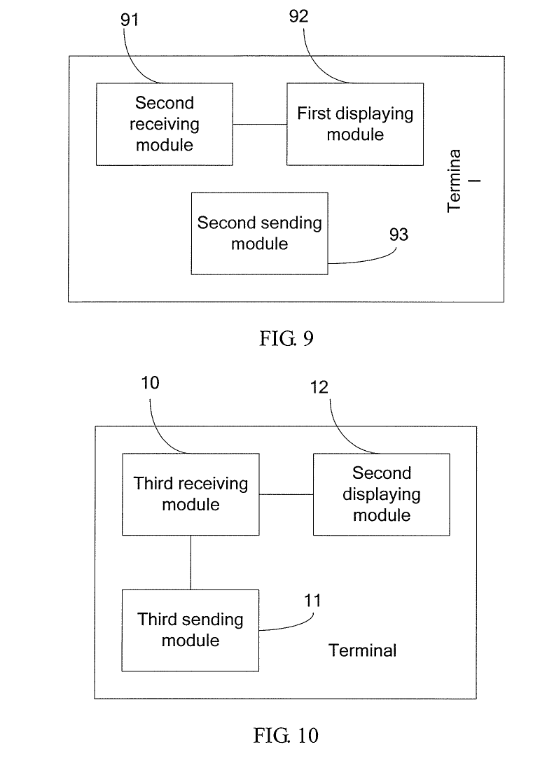

FIG. 9 is a schematic structural diagram of a terminal according to another embodiment of the present invention. As shown in FIG. 9, the terminal specifically includes the following:

A second receiving module 91 is configured to receive a service content request and a service content request response sent by a proxy server.

It should be noted that the service content request is a service content request sent by another terminal to the proxy server, and the service content request response is returned by a further terminal to the proxy server according to the service content request, where the proxy server searches, according to an account of the terminal included in the service content request, a preset proxy relationship table corresponding to the account of the terminal, and if it is learned, according to the proxy relationship table, that a service item included in the service content request is a proxy-enabled service item, sends the service content request to the further terminal corresponding to the proxy-enabled service item, so that the further terminal returns the service content request response to the proxy server according to the service content request; and the terminal is a terminal different from the further terminal.

A first displaying module 92 is configured to display the service content request and the service content request response.

In an optional embodiment of the present invention, the terminal further includes:

a second sending module 93, configured to send a proxy setting request to the proxy server, where the proxy setting request includes at least one to-be-proxied service item and an account of the further terminal corresponding to the service item, so that the proxy server sends the proxy setting request to the further terminal; where

the second receiving module 91 is further configured to receive a proxy setting response sent by the proxy server and establish a correspondence between the to-be-proxied service item and the account of the further terminal, where the proxy setting response is a proxy setting response returned by the further terminal to the proxy server according to the proxy setting request.

In an optional embodiment of the present invention, the second sending module 93 is further configured to send a proxy enabling request to the proxy server, where the proxy enabling request includes at least one to-be-proxy-enabled service item, so that the proxy server searches the proxy relationship table corresponding to the account of the terminal, activates the to-be-proxy-enabled service item to make it a proxy-enabled service item, obtains the account of the further terminal corresponding to the proxy-enabled service item, and sends a proxy enabling notification of the service item to the further terminal.

The second receiving module 91 is further configured to receive the proxy enabling notification that is of the service item and sent by the proxy server, where the proxy enabling notification of the service item includes proxy prompt content corresponding to the terminal.

The first displaying module 92 is further configured to display the proxy prompt content corresponding to the terminal.

In an optional embodiment of the present invention, the proxy prompt content corresponding to the terminal includes text prompt content and personal avatar prompt content that are corresponding to the terminal; and the text prompt content corresponding to the terminal includes prompt content indicating that the terminal is being proxied by the further terminal.

The first displaying module 92 is specifically configured to:

display the prompt content indicating that the terminal is being proxied by the further terminal; and display both a personal avatar of the terminal and a personal avatar of the further terminal.

It should be noted that the foregoing service item includes at least one of text chatting, an incoming call, an email, a conference, and conference schedule management.

In this embodiment of the present invention, a terminal device displays a service content request that is forwarded by a proxy server and from another terminal, and a service content request response from a further terminal, so as to implement that when the terminal device terminal is proxied by the further terminal, the terminal device terminal can also obtain service content proxied by the further terminal. Moreover, a service item in this embodiment of the present invention includes but is not limited to at least one of text chatting, an incoming call, an email, a conference, and conference schedule management. Proxied items are abundant and expandable. Moreover, in this embodiment of the present invention, the terminal device terminal performs visual displaying according to corresponding proxy prompt content sent by the proxy server. For example, after proxy is enabled, personal avatars displayed by the terminal device terminal include a personal avatar of the terminal device terminal and a personal avatar of the further terminal. For another example, a text prompt displayed by the terminal device terminal is “You are being proxied by the further terminal”, which may improve user experience.

FIG. 10 is a schematic structural diagram of a terminal according to another embodiment of the present invention. As shown in FIG. 10, the terminal specifically includes the following:

A third receiving module 10 is configured to receive a service content request sent by a proxy server.

It should be noted that the service content request is a service content request sent by another terminal to the proxy server, so that the proxy server searches, according to an account of a further terminal included in the service content request, a preset proxy relationship table corresponding to the account of the further terminal, and if it is learned, according to the proxy relationship table, that a service item included in the service content request is a proxy-enabled service item, sends the service content request to the terminal corresponding to the proxy-enabled service item; and the terminal is a terminal different from the further terminal.

A third sending module 11 is configured to return, on the basis of the service content request received by the third receiving module, a service content request response to the proxy server, so that the proxy server sends the service content request response to the other terminal and the further terminal.

In an optional embodiment of the present invention, the third receiving module 10 is further configured to receive a proxy setting request sent by the proxy server, where the proxy setting request includes at least one to-be-proxied service item and an account of the terminal corresponding to the service item, and the proxy setting request is a proxy setting request sent by the further terminal to the proxy server.

The third sending module 11 is further configured to send a proxy setting response to the proxy server according to the proxy setting request, so that the proxy server creates, according to the proxy setting response, the proxy relationship table corresponding to the account of the further terminal, and sends the proxy setting response to the further terminal, where the proxy relationship table includes a correspondence between the to-be-proxied service item and the account of the terminal.

In an optional embodiment of the present invention, the third receiving module 10 is further configured to receive a proxy enabling notification that is of the service item corresponding to the terminal and sent by the proxy server, where the proxy enabling notification of the service item corresponding to the terminal includes proxy prompt content corresponding to the terminal.

In an optional embodiment of the present invention, the terminal further includes:

a second displaying module 12, configured to display the proxy prompt content that is received by the third receiving module and corresponds to the terminal.

In an optional embodiment of the present invention, the proxy prompt content corresponding to the terminal includes text prompt content and personal avatar prompt content that are corresponding to the terminal; and the text prompt content corresponding to the terminal includes prompt content indicating that the terminal is serving as a proxy for the further terminal.

The second displaying module 12 is specifically configured to:

display the prompt content indicating that the terminal is serving as a proxy for the further terminal; and display both a personal avatar of the terminal and a personal avatar of the further terminal.

It should be noted that the service item includes at least one of text chatting, an incoming call, an email, a conference, and conference schedule management.

In this embodiment of the present invention, when a terminal device terminal receives a service content request that is forwarded by a proxy server and from another terminal, the terminal device terminal sends a service content request response to the other terminal in a timely manner according to the service content request, which may implement that when the other terminal sends the service content request to a further terminal (a proxied terminal) even without learning a proxy relationship, the proxy server may send the service content request to the terminal device terminal (a proxy terminal) in a timely manner, so that the terminal device terminal replies to the other terminal in a timely manner, which improves proxy efficiency and may resolve a problem of low proxy efficiency of a method based on email proxy.

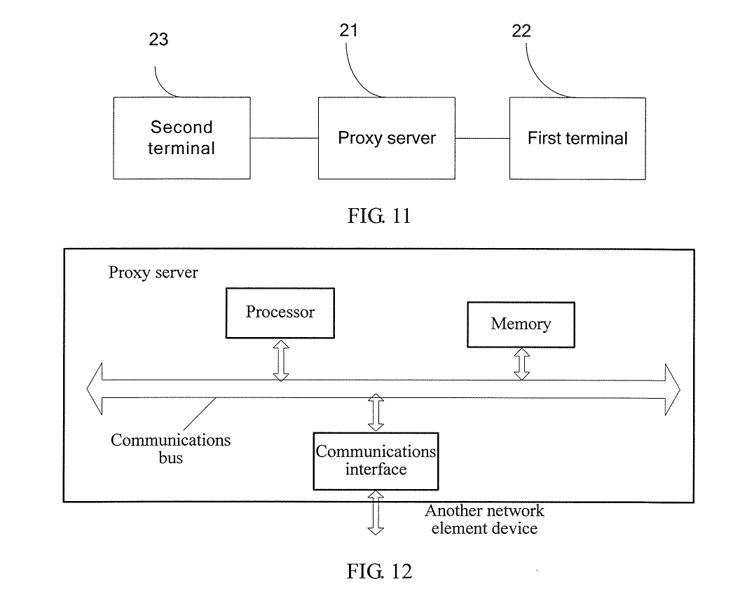

FIG. 11 is a schematic structural diagram of a proxy relationship processing system according to another embodiment of the present invention. As shown in FIG. 11, the system includes a proxy server 21, a first terminal 22, and a second terminal 23, where

the proxy server 21 is the proxy server according to the embodiment shown in FIG. 8;

the first terminal 22 is the terminal according to the embodiment shown in FIG. 9; and

the second terminal 23 is the terminal according to the embodiment shown in FIG. 10.

In this embodiment of the present invention, a proxy server may, when receiving a service content request sent by another terminal to a first terminal, determine whether a service item included in the service content request is a proxy-enabled service item; and if yes, directly send the service content request to a second terminal corresponding to the proxy-enabled service item, so that the second terminal makes a service content request response in a timely manner, which may implement that when the other terminal sends the service content request to the first terminal (a proxied terminal) even without learning a proxy relationship, the proxy server may send the service content request to the second terminal (a proxy terminal) in a timely manner, so that the second terminal replies to the other terminal in a timely manner, which improves proxy efficiency, and may resolve a problem of low proxy efficiency of a method based on email proxy.

A proxied item or the service item in this embodiment of the present invention includes but is not limited to at least one of text chatting, an incoming call, an email, a conference, and conference schedule management. The proxied items are abundant and expandable. Moreover, the second terminal, as a proxy terminal, may, according to an instruction of a proxy, make a flexible response to the service content request sent by the other terminal, which may resolve a problem of limited application of a method based on proxy by using a proxy robot.

Moreover, in this embodiment of the present invention, the first terminal and the second terminal separately perform visual displaying according to corresponding proxy prompt content sent by the proxy server. For example, after proxy is enabled, personal avatars displayed by the first terminal include a personal avatar of the first terminal and a personal avatar of the second terminal. For another example, a text prompt displayed by the first terminal is “You are being proxied by the second terminal”, or a text prompt displayed by the second terminal is “You are acting as a proxy for the first terminal”, which may improve user experience.

FIG. 12 is a schematic structural diagram of a proxy server according to another embodiment of the present invention. As shown in FIG. 12, the proxy server includes a processor, a memory, and a communications bus, where the processor and the memory are connected by using the communications bus, and the memory stores an instruction for implementing a proxy relationship processing method. Further, the proxy server further includes a communications interface, and makes a communication connection to another network element device (such as a terminal) through the communications interface.

When the processor invokes the instruction in the memory, the following steps may be executed:

receiving a service content request sent by another terminal, where the service content request includes an account of a first terminal and a service item;

searching, according to the account of the first terminal, a preset proxy relationship table corresponding to the account of the first terminal; and

if it is learned, according to the proxy relationship table, that the service item is a proxy-enabled service item, sending the service content request to a second terminal corresponding to the proxy-enabled service item, so that the second terminal sends a service content request response to the other terminal according to the service content request.

For example, before the receiving a service content request sent by another terminal, the steps include:

receiving a proxy setting request sent by the first terminal, where the proxy setting request includes at least one to-be-proxied service item and an account of the second terminal corresponding to the service item;

sending the proxy setting request to the second terminal corresponding to the account of the second terminal, so that the second terminal returns a proxy setting response;

receiving the proxy setting response and creating the proxy relationship table corresponding to the account of the first terminal, where the proxy relationship table includes a correspondence between the to-be-proxied service item and the account of the second terminal; and

sending, to the first terminal, the proxy setting response sent by the second terminal, so that the first terminal establishes the correspondence between the to-be-proxied service item and the account of the second terminal.

For example, after the receiving the proxy setting response and creating the proxy relationship table corresponding to the account of the first terminal, the steps include:

receiving a proxy enabling request sent by the first terminal, where the proxy enabling request includes at least one to-be-proxy-enabled service item;

searching the proxy relationship table corresponding to the account of the first terminal, activating the to-be-proxy-enabled service item to make it a proxy-enabled service item, and obtaining the account of the second terminal corresponding to the proxy-enabled service item; and

sending proxy enabling notifications of the service item respectively to the first terminal and the second terminal, where the proxy enabling notifications of the service item each include corresponding proxy prompt content, so that the first terminal and the second terminal perform displaying respectively according to their respective proxy prompt content.

For example, the following steps may be further executed:

obtaining a friend list corresponding to the account of the first terminal; and

sending a proxy relationship notification of the proxy-enabled service item to any terminal corresponding to the friend list, where the proxy relationship notification includes the proxy-enabled service item, the account of the second terminal, and the account of the first terminal.

For example, the service item includes at least one of text chatting, an incoming call, an email, a conference, and conference schedule management.

In this embodiment of the present invention, a proxy server may, when receiving a service content request sent by another terminal to a first terminal, determine whether a service item included in the service content request is a proxy-enabled service item; and if yes, directly send the service content request to a second terminal corresponding to the proxy-enabled service item, so that the second terminal makes a service content request response in a timely manner, which may implement that when the other terminal sends the service content request to the first terminal (a proxied terminal) even without learning a proxy relationship, the proxy server may send the service content request to the second terminal (a proxy terminal) in a timely manner, so that the second terminal replies to the other terminal in a timely manner, which improves proxy efficiency, and may resolve a problem of low proxy efficiency of a method based on email proxy.

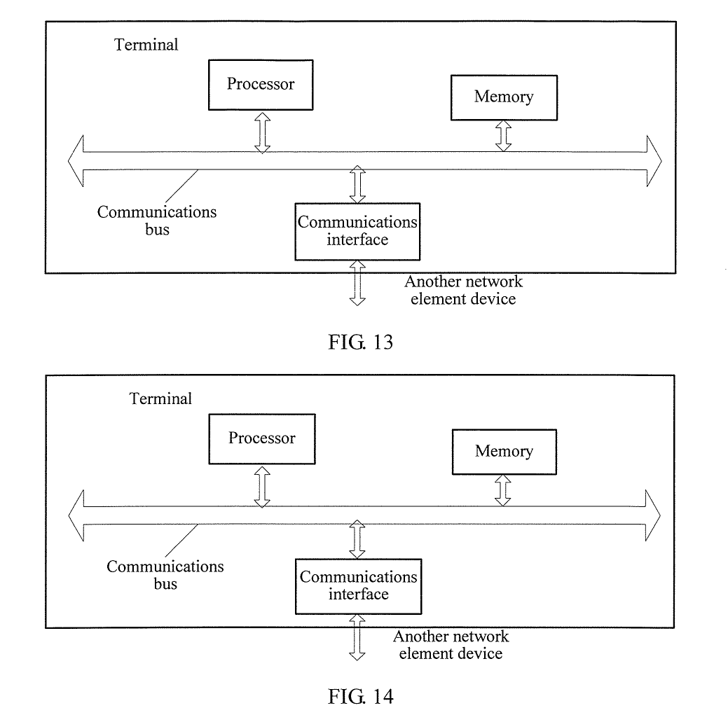

FIG. 13 is a schematic structural diagram of a terminal according to another embodiment of the present invention. As shown in FIG. 13, the terminal includes a processor, a memory, and a communications bus, where the processor and the memory are connected by using the communications bus, and the memory stores an instruction for implementing a proxy relationship processing method. Further, the terminal further includes a communications interface, and makes a communication connection to another network element device (a proxy server or another terminal) through the communications interface.

When the processor invokes the instruction in the memory, the following steps may be executed:

receiving a service content request and a service content request response sent by a proxy server, where the service content request is a service content request sent by another terminal to the proxy server, and the service content request response is sent by a further terminal to the other terminal according to the service content request, where the proxy server searches, according to an account of the terminal included in the service content request, a preset proxy relationship table corresponding to the account of the terminal, and if it is learned, according to the proxy relationship table, that a service item included in the service content request is a proxy-enabled service item, sends the service content request to the further terminal corresponding to the proxy-enabled service item, so that the further terminal sends the service content request response to the other terminal according to the service content request; and

displaying the service content request and the service content request response.

For example, before the receiving a service content request and a service content request response sent by a proxy server, the steps include:

sending a proxy setting request to the proxy server, where the proxy setting request includes at least one to-be-proxied service item and an account of the further terminal corresponding to the service item, so that the proxy server sends the proxy setting request to the further terminal; and

receiving a proxy setting response sent by the proxy server and establishing a correspondence between the to-be-proxied service item and the account of the further terminal, where

the proxy setting response is a proxy setting response returned by the further terminal to the proxy server according to the proxy setting request.

For example, after the receiving a proxy setting response sent by the proxy server and establishing a correspondence between the to-be-proxied service item and the account of the further terminal, the steps include:

sending a proxy enabling request to the proxy server, where the proxy enabling request includes at least one to-be-proxy-enabled service item, so that the proxy server searches the proxy relationship table corresponding to the account of the terminal, activates the to-be-proxy-enabled service item to make it a proxy-enabled service item, obtains the account of the further terminal corresponding to the proxy-enabled service item, and sends a proxy enabling notification of the service item to the further terminal;

receiving the proxy enabling notification that is of the service item and sent by the proxy server, where the proxy enabling notification of the service item includes proxy prompt content corresponding to the terminal; and

displaying the proxy prompt content corresponding to the terminal.

For example, the proxy prompt content corresponding to the terminal includes text prompt content and personal avatar prompt content that are corresponding to the terminal; and the text prompt content corresponding to the terminal includes prompt content indicating that the terminal is being proxied by the further terminal.

The displaying the proxy prompt content corresponding to the terminal specifically includes:

displaying the prompt content indicating that the terminal is being proxied by the further terminal; and

displaying both a personal avatar of the terminal and a personal avatar of the further terminal.

For example, the service item includes at least one of text chatting, an incoming call, an email, a conference, and conference schedule management.

In this embodiment of the present invention, a proxy server may, when receiving a service content request sent by another terminal to a first terminal, determine whether a service item included in the service content request is a proxy-enabled service item; and if yes, directly send the service content request to a second terminal corresponding to the proxy-enabled service item, so that the second terminal makes a service content request response in a timely manner, which may implement that when the other terminal sends the service content request to the first terminal (a proxied terminal) even without learning a proxy relationship, the proxy server may send the service content request to the second terminal (a proxy terminal) in a timely manner, so that the second terminal replies to the other terminal in a timely manner, which improves proxy efficiency, and may resolve a problem of low proxy efficiency of a method based on email proxy.

FIG. 14 is a schematic structural diagram of a terminal according to another embodiment of the present invention. As shown in FIG. 14, the terminal includes a processor, a memory, and a communications bus, where the processor and the memory are connected by using the communications bus, and the memory stores an instruction for implementing a proxy relationship processing method. The terminal may further include a communications interface, and makes a communication connection to another network element device (such as a proxy server or another terminal) through the communications interface.

When the processor invokes the instruction in the memory, the following steps may be executed:

receiving a service content request sent by a proxy server, where the service content request is a service content request sent by another terminal to the proxy server, so that the proxy server searches, according to an account of a further terminal included in the service content request, a preset proxy relationship table corresponding to the account of the further terminal, and if it is learned, according to the proxy relationship table, that a service item included in the service content request is a proxy-enabled service item, sends the service content request to a terminal corresponding to the proxy-enabled service item; and

returning a service content request response to the proxy server according to the service content request, so that the proxy server sends the service content request response to the other terminal and the further terminal.

For example, before the receiving a service content request sent by a proxy server, the steps include:

receiving a proxy setting request sent by the proxy server, where the proxy setting request includes at least one to-be-proxied service item and an account of the terminal corresponding to the service item, and the proxy setting request is a proxy setting request sent by the further terminal to the proxy server; and

sending a proxy setting response to the proxy server according to the proxy setting request, so that the proxy server creates, according to the proxy setting response, the proxy relationship table corresponding to the account of the further terminal, and sends the proxy setting response to the further terminal, where the proxy relationship table includes a correspondence between the to-be-proxied service item and the account of the terminal.

For example, after the sending a proxy setting response to the proxy server according to the proxy setting request, the steps include:

receiving a proxy enabling notification that is of the service item corresponding to the terminal and sent by the proxy server, where the proxy enabling notification of the service item corresponding to the terminal includes proxy prompt content corresponding to the terminal; and

displaying the proxy prompt content corresponding to the terminal.

For example, the proxy prompt content corresponding to the terminal includes text prompt content and personal avatar prompt content that are corresponding to the terminal; and the text prompt content corresponding to the terminal includes prompt content indicating that the terminal is serving as a proxy for the further terminal.

The displaying the proxy prompt content corresponding to the terminal specifically includes:

displaying the prompt content indicating that the terminal is serving as a proxy for the further terminal; and

displaying both a personal avatar of the terminal and a personal avatar of the further terminal.

For example, the service item includes at least one of text chatting, an incoming call, an email, a conference, and conference schedule management.

In this embodiment of the present invention, a proxy server may, when receiving a service content request sent by another terminal to a first terminal, determine whether a service item included in the service content request is a proxy-enabled service item; and if yes, directly send the service content request to a second terminal corresponding to the proxy-enabled service item, so that the second terminal makes a service content request response in a timely manner, which may implement that when the other terminal sends the service content request to the first terminal (a proxied terminal) even without learning a proxy relationship, the proxy server may send the service content request to the second terminal (a proxy terminal) in a timely manner, so that the second terminal replies to the other terminal in a timely manner, which improves proxy efficiency, and may resolve a problem of low proxy efficiency of a method based on email proxy.

It may be clearly understood by persons skilled in the art that, for ease and brevity of description, for a specific working process of the foregoing system, apparatus, and unit, reference may be made to a corresponding process in the foregoing method embodiments, and details are not described herein again.

In the several embodiments provided in the present application, it should be understood that the disclosed system, apparatus, and method may be implemented in other manners. For example, the described apparatus embodiment is merely exemplary. For example, the unit division is merely logical function division and may be other division in actual implementation. For example, a plurality of units or components may be combined or integrated into another system, or some features may be ignored or not performed. Furthermore, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. A part or all of the units may be selected according to an actual need to achieve the purposes of the solutions of the embodiments.

In addition, functional units in the embodiments of the present invention may be integrated into one processing unit, or each of the units may exist alone physically, or two or more units are integrated into one unit. The integrated unit may be implemented by hardware in addition to a software functional unit, or by hardware only.

The integrated unit implemented in the form of software functional unit may be stored in a computer readable storage medium. The software functional unit is stored in a storage medium, and includes several instructions for instructing a computer device (which may be a personal computer, a server, a network device, or the like) to perform a part of the steps of the methods described in the embodiments of the present invention. The foregoing storage medium includes any medium that can store program code, such as a removable hard disk, a read-only memory (Read-Only Memory, ROM), a random access memory (Random Access Memory, RAM), a magnetic disk, or an optical disc.

Finally, it should be noted that the foregoing embodiments are merely intended for describing the technical solutions of the present invention other than limiting the present invention. Although the present invention is described in detail with reference to the foregoing embodiments, persons of ordinary skill in the art should understand that they may still make modifications to the technical solutions described in the foregoing embodiments or make equivalent replacements to some technical features thereof, without departing from the protection scope of the technical solutions of the embodiments of the present invention.

What is claimed is:

1. A proxy relationship processing method, comprising:
receiving, by a proxy server, a service content request sent by another terminal, wherein the service content request comprises an account of a first terminal and a service item;
searching, according to the account of the first terminal, a preset proxy relationship table corresponding to the account of the first terminal; and
sending the service content request to a second terminal corresponding to a proxy-enabled service item when it is learned, according to the proxy relationship table, that the service item is the proxy-enabled service item, so that the second terminal sends a service content request response to the other terminal according to the service content request.

2. The method according to claim 1, wherein before receiving, by a proxy server, a service content request sent by another terminal, the method comprises:
receiving, by the proxy server, a proxy setting request sent by the first terminal, wherein the proxy setting request comprises at least one to-be-proxied service item and an account of the second terminal corresponding to the service item;
sending the proxy setting request to the second terminal corresponding to the account of the second terminal, so that the second terminal returns a proxy setting response;
receiving the proxy setting response and creating the proxy relationship table corresponding to the account of the first terminal, wherein the proxy relationship table comprises a correspondence between the to-be-proxied service item and the account of the second terminal; and
sending, to the first terminal, the proxy setting response sent by the second terminal, so that the first terminal establishes the correspondence between the to-be-proxied service item and the account of the second terminal.

3. The method according to claim 2, wherein after receiving the proxy setting response and creating the proxy relationship table corresponding to the account of the first terminal, the method comprises:
receiving, by the proxy server, a proxy enabling request sent by the first terminal, wherein the proxy enabling request comprises at least one to-be-proxy-enabled service item;
searching the proxy relationship table corresponding to the account of the first terminal, activating the to-be-proxy-enabled service item to make it a proxy-enabled service item, and obtaining the account of the second terminal corresponding to the proxy-enabled service item; and
sending proxy enabling notifications of the service item respectively to the first terminal and the second terminal, wherein the proxy enabling notifications of the service item each comprise corresponding proxy prompt content, so that the first terminal and the second terminal perform displaying respectively according to their respective proxy prompt content.

4. The method according to claim 1, further comprising:
obtaining, by the proxy server, a friend list corresponding to the account of the first terminal; and
sending a proxy relationship notification of the proxy-enabled service item to any terminal corresponding to the friend list, wherein the proxy relationship notification comprises the proxy-enabled service item, the account of the second terminal, and the account of the first terminal.

5. A proxy relationship processing method, comprising:
receiving, by a first terminal, a service content request and a service content request response sent by a proxy server, wherein the service content request is a service content request sent by another terminal to the proxy server, and the service content request response is sent by a second terminal to the other terminal according to the service content request, wherein the proxy server searches, according to an account of the first terminal comprised in the service content request, a preset proxy relationship table corresponding to the account of the first terminal, and if it is learned, according to the proxy relationship table, that a service item comprised in the service content request is a proxy-enabled service item, sends the service content request to the second terminal corresponding to the proxy-enabled service item, so that the second terminal sends the service content request response to the other terminal according to the service content request; and
displaying the service content request and the service content request response.

6. The method according to claim 5, wherein before receiving, by a first terminal, a service content request and a service content request response sent by a proxy server, the method comprises:
sending, by the first terminal, a proxy setting request to the proxy server, wherein the proxy setting request comprises at least one to-be-proxied service item and an account of the second terminal corresponding to the service item, so that the proxy server sends the proxy setting request to the second terminal; and
receiving a proxy setting response sent by the proxy server and establishing a correspondence between the to-be-proxied service item and the account of the second terminal, wherein
the proxy setting response is a proxy setting response returned by the second terminal to the proxy server according to the proxy setting request.

7. The method according to claim 6, wherein after receiving a proxy setting response sent by the proxy server and establishing a correspondence between the to-be-proxied service item and the account of the second terminal, the method comprises:
sending, by the first terminal, a proxy enabling request to the proxy server, wherein the proxy enabling request comprises at least one to-be-proxy-enabled service item, so that the proxy server searches the proxy relationship table corresponding to the account of the first terminal, activates the to-be-proxy-enabled service item to make it a proxy-enabled service item, obtains the account of the second terminal corresponding to the proxy-enabled service item, and sends a proxy enabling notification of the service item to the second terminal;
receiving a proxy enabling notification that is of the service item and sent by the proxy server, wherein the proxy enabling notification of the service item comprises proxy prompt content corresponding to the first terminal; and
displaying the proxy prompt content corresponding to the first terminal.

8. The method according to claim 7, wherein:
the proxy prompt content corresponding to the first terminal comprises text prompt content and personal avatar prompt content that are corresponding to the first terminal;
the text prompt content corresponding to the first terminal comprises prompt content indicating that the first terminal is being proxied by the second terminal; and
displaying the proxy prompt content corresponding to the first terminal comprises:
displaying the prompt content indicating that the first terminal is being proxied by the second terminal, and
displaying both a personal avatar of the first terminal and a personal avatar of the second terminal.

9. A proxy relationship processing method, comprising:
receiving, by a second terminal, a service content request sent by a proxy server, wherein the service content request is a service content request sent by another terminal to the proxy server, so that the proxy server searches, according to an account of a first terminal comprised in the service content request, a preset proxy relationship table corresponding to the account of the first terminal, and if it is learned, according to the proxy relationship table, that a service item comprised in the service content request is a proxy-enabled service item, sends the service content request to a second terminal corresponding to the proxy-enabled service item; and
returning a service content request response to the proxy server according to the service content request, so that the proxy server sends the service content request response to the other terminal and the first terminal.

10. The method according to claim 9, wherein before receiving, by a second terminal, a service content request sent by a proxy server, the method comprises:
receiving, by the second terminal, a proxy setting request sent by the proxy server, wherein the proxy setting request comprises at least one to-be-proxied service item and an account of the second terminal corresponding to the service item, and the proxy setting request is a proxy setting request sent by the first terminal to the proxy server; and
sending a proxy setting response to the proxy server according to the proxy setting request, so that the proxy server creates, according to the proxy setting response, the proxy relationship table corresponding to the account of the first terminal, and sends the proxy setting response to the first terminal, wherein the proxy relationship table comprises a correspondence between the to-be-proxied service item and the account of the second terminal.

11. The method according to claim 10, wherein after sending a proxy setting response to the proxy server according to the proxy setting request, the method comprises:
receiving, by the second terminal, a proxy enabling notification that is of the service item corresponding to the second terminal and sent by the proxy server, wherein the proxy enabling notification of the service item corresponding to the second terminal comprises proxy prompt content corresponding to the second terminal; and
displaying the proxy prompt content corresponding to the second terminal.

12. The method according to claim 11, wherein:
the proxy prompt content corresponding to the second terminal comprises text prompt content and personal avatar prompt content that are corresponding to the second terminal;
the text prompt content corresponding to the second terminal comprises prompt content indicating that the second terminal is serving as a proxy for the first terminal; and
displaying the proxy prompt content corresponding to the second terminal specifically comprises:
displaying the prompt content indicating that the second terminal is serving as a proxy for the first terminal, and
displaying both a personal avatar of the second terminal and a personal avatar of the first terminal.

13. A proxy server, comprising a processor, a memory, and a communications bus, wherein the processor and the memory are connected by using the communications bus, and the memory stores an instruction for implementing a proxy relationship processing method; when the processor invokes the instruction in the memory, the following steps may be executed:
receiving a service content request sent by another terminal, wherein the service content request comprises an account of a first terminal and a service item;
searching, according to the account of the first terminal, a preset proxy relationship table corresponding to the account of the first terminal; and
sending the service content request to a second terminal corresponding to a proxy-enabled service item when it is learned, according to the proxy relationship table, that the service item is the proxy-enabled service item, so that the second terminal sends a service content request response to the other terminal according to the service content request.

14. The proxy server according to claim 13, wherein before receiving a service content request sent by another terminal, the steps comprise:
receiving a proxy setting request sent by the first terminal, wherein the proxy setting request comprises at least one to-be-proxied service item and an account of the second terminal corresponding to the service item;
sending the proxy setting request to the second terminal corresponding to the account of the second terminal, so that the second terminal returns a proxy setting response;
receiving the proxy setting response and creating the proxy relationship table corresponding to the account of the first terminal, wherein the proxy relationship table comprises a correspondence between the to-be-proxied service item and the account of the second terminal; and
sending, to the first terminal, the proxy setting response sent by the second terminal, so that the first terminal establishes the correspondence between the to-be-proxied service item and the account of the second terminal.

15. The proxy server according to claim 14, wherein after receiving the proxy setting response and creating the proxy relationship table corresponding to the account of the first terminal, the steps comprise:
receiving a proxy enabling request sent by the first terminal, wherein the proxy enabling request comprises at least one to-be-proxy-enabled service item;
searching the proxy relationship table corresponding to the account of the first terminal, activating the to-be-proxy-enabled service item to make it a proxy-enabled service item, and obtaining the account of the second terminal corresponding to the proxy-enabled service item; and
sending proxy enabling notifications of the service item respectively to the first terminal and the second terminal, wherein the proxy enabling notifications of the service item each comprise corresponding proxy prompt content, so that the first terminal and the second terminal perform displaying respectively according to their respective proxy prompt content.

16. The proxy server according to claim 13, wherein the steps further comprise:
obtaining a friend list corresponding to the account of the first terminal; and
sending a proxy relationship notification of the proxy-enabled service item to any terminal corresponding to the friend list, wherein the proxy relationship notification comprises the proxy-enabled service item, the account of the second terminal, and the account of the first terminal.

17. A terminal, comprising a processor, a memory, and a communications bus, wherein the processor and the memory are connected by using the communications bus, and the memory stores an instruction for implementing a proxy relationship processing method; when the processor invokes the instruction in the memory, the following steps may be executed:
receiving a service content request and a service content request response sent by a proxy server, wherein the service content request is a service content request sent by another terminal to the proxy server, and the service content request response is sent by a further terminal to the other terminal according to the service content request, wherein the proxy server searches, according to an account of the terminal comprised in the service content request, a preset proxy relationship table corresponding to the account of the terminal, and sends the service content request to the further terminal corresponding to aproxy-enabled service item when it is learned, according to the proxy relationship table, that a service item comprised in the service content request is the proxy-enabled service item, so that the further terminal sends the service content request response to the other terminal according to the service content request; and
displaying the service content request and the service content request response.

18. The terminal according to claim 17, wherein before receiving a service content request and a service content request response sent by a proxy server, the steps comprise:
sending a proxy setting request to the proxy server, wherein the proxy setting request comprises at least one to-be-proxied service item and an account of the further terminal corresponding to the service item, so that the proxy server sends the proxy setting request to the further terminal; and
receiving a proxy setting response sent by the proxy server and establishing a correspondence between the to-be-proxied service item and the account of the further terminal, wherein
the proxy setting response is a proxy setting response returned by the further terminal to the proxy server according to the proxy setting request.

19. The terminal according to claim 18, wherein after receiving a proxy setting response sent by the proxy server and establishing a correspondence between the to-be-proxied service item and the account of the further terminal, the steps comprise:
sending a proxy enabling request to the proxy server, wherein the proxy enabling request comprises at least one to-be-proxy-enabled service item, so that the proxy server searches the proxy relationship table corresponding to the account of the terminal, activates the to-be-proxy-enabled service item to make it a proxy-enabled service item, obtains the account of the further terminal corresponding to the proxy-enabled service item, and sends a proxy enabling notification of the service item to the further terminal;
receiving the proxy enabling notification that is of the service item and sent by the proxy server, wherein the proxy enabling notification of the service item comprises proxy prompt content corresponding to the terminal; and
displaying the proxy prompt content corresponding to the terminal.

20. The terminal according to claim 19, wherein:
the proxy prompt content corresponding to the terminal comprises text prompt content and personal avatar prompt content that are corresponding to the terminal;
the text prompt content corresponding to the terminal comprises prompt content indicating that the terminal is being proxied by the further terminal; and
displaying the proxy prompt content corresponding to the terminal specifically comprises:
displaying the prompt content indicating that the terminal is being proxied by the further terminal, and
displaying both a personal avatar of the terminal and a personal avatar of the further terminal.

21. A terminal, comprising a processor, a memory, and a communications bus, wherein the processor and the memory are connected by using the communications bus, and the memory stores an instruction for implementing a proxy relationship processing method; when the processor invokes the instruction in the memory, the following steps may be executed:
receiving a service content request sent by a proxy server, wherein the service content request is a service content request sent by another terminal to the proxy server, so that the proxy server searches, according to an account of a further terminal comprised in the service content request, a preset proxy relationship table corresponding to the account of the further terminal, and sends the service content request to a terminal corresponding to a proxy-enabled service item when it is learned, according to the proxy relationship table, that a service item comprised in the service content request is the proxy-enabled service item; and
returning a service content request response to the proxy server according to the service content request, so that the proxy server sends the service content request response to the other terminal and the further terminal.

22. The terminal according to claim 21, wherein before receiving a service content request sent by a proxy server, the steps comprise:
receiving a proxy setting request sent by the proxy server, wherein the proxy setting request comprises at least one to-be-proxied service item and an account of the terminal corresponding to the service item, and the proxy setting request is a proxy setting request sent by the further terminal to the proxy server; and
sending a proxy setting response to the proxy server according to the proxy setting request, so that the proxy server creates, according to the proxy setting response, the proxy relationship table corresponding to the account of the further terminal, and sends the proxy setting response to the further terminal, wherein the proxy relationship table comprises a correspondence between the to-be-proxied service item and the account of the terminal.

23. The terminal according to claim 22, wherein after sending a proxy setting response to the proxy server according to the proxy setting request, the steps comprise:
receiving a proxy enabling notification that is of the service item corresponding to the terminal and sent by the proxy server, wherein the proxy enabling notification of the service item corresponding to the terminal comprises proxy prompt content corresponding to the terminal; and
displaying the proxy prompt content corresponding to the terminal.

24. The terminal according to claim 23, wherein:
the proxy prompt content corresponding to the terminal comprises text prompt content and personal avatar prompt content that are corresponding to the terminal;
the text prompt content corresponding to the terminal comprises prompt content indicating that the terminal is serving as a proxy for the further terminal; and
displaying the proxy prompt content corresponding to the terminal specifically comprises:
displaying the prompt content indicating that the terminal is serving as a proxy for the further terminal, and
displaying both a personal avatar of the terminal and a personal avatar of the further terminal.
